(19) United States
(12) Patent Application Publication
(10) Pub. No.: US 2026/0223809 A1
(43) Pub. Date: Aug. 6, 2026

(54) STAINLESS STEEL ANIMAL WASTE RECEPTACLE AND ACCESSORIES FOR USE THEREWITH

(71) Applicant: Jacklyn Ki, Los Angeles, CA (US)

(72) Inventor: Jacklyn Ki, Los Angeles, CA (US)

(21) Appl. No.: 19/576,073

(22) Filed: Mar. 24, 2026

Related U.S. Application Data
(63) Continuation-in-part of application No. 17/515,905, filed on Nov. 1, 2021.

(51) Int. Cl. A01K 1/01

(52) U.S. Cl. CPC A01K 1/0114; A01K 1/0112

(57) ABSTRACT

Embodiments of the present invention include an animal litter container and materials and surfaces used therein. Embodiments also include a lid and a removable trivet. Embodiments also include a scoop hanger for use with an animal litter scoop and an animal litter container system. Embodiments also include a removable protective liner for an entryway of an animal litter container. Embodiments also include a removable mat for use with an animal litter container. Embodiments also include a filter insert.

### BACKGROUND OF THE INVENTION

The present application especially relates to an animal waste receptacle and materials, methods and sequence of manufacturing steps therefor. More particularly, the present invention relates to a cat waste receptacle and a method and sequence of manufacturing steps for producing it.

Animal waste receptacles may be commonly used by indoor animals, such as cats, to collect the animal's urine and feces. In general, most animal waste receptacles are formed with a plastic material. Granular cat litter may be placed in the bottom of the waste receptacle. The granular cat litter may be used to absorb moisture and odor caused by the animal's bodily functions. Further, since cats like to use their paws in a backward sweeping motion to cover their feces, the granular cat litter may satisfy a cat's instinctive desire to hide their scent by allowing them to bury their waste.

Even with proper cleaning and disinfecting of an animal waste receptacle, it is generally recommended that animal waste receptacles be replaced with a new one once or twice a year. Plastic, non-stick and Teflon® coated cat waste receptacles may be easily scratched and damaged by the cat using the waste receptacle. Channels formed by these scratches may harbor odor and bacteria. Further, cat urine is highly acidic. These discarded cat waste receptacles end up in landfills and will not biodegrade to any significant degree.

Biologically cats turn in circular motions right before and right after the elimination, however, most cat waste receptacles are in rectangular shape which obstructs the cats from making full circular movements. The length in which a cat can turn is limited to the shorter side of the rectangular, and therefore, it would most biologically appropriate to provide a cat waste receptacle with a circular interior to allow cats to turn in circular motions without any obstruction.

Typically cats squat down when eliminating, however, many cats urinate as high as 25 inches. Existing cat waste receptacles do not offer such a high wall height that is formed as one unibody but instead are typically made in 2 parts with an extended wall and bottom tray, which causes the urine to leak between the seams of the extended wall part and bottom tray. Therefore, it would be desirable to provide a 300 Series Stainless Steel cat waste receptacle that has a high vertical wall taller than 20 inches for high-urinating, non-squatting cats and to prevent urine spill over the common shallow 6-8 inch cat waste receptacle wall (although in some embodiments other stainless steel alloys, including but not limited to 200-series stainless steels, may also be used, despite 300-series stainless steel and in particular 316 stainless steel being preferred for corrosion resistance). 316 is the only grade that has molybdenum (molybdenum is the key element that resists chloride in feline urine).

However, when a 300 series steel object has a height or depth that is higher or deeper than 8 inches it cannot be molded or casted or deep drawn out without compromising trade-offs because it is known in the art that stainless steel plate cannot stretch, deep-draw or dent deeper than 8 inches. Only less malleable and rigid 300 Series Stainless Steel plate can be rolled and welded to achieve a wall height that is higher or deeper than 8 inches and a wall stands up straight without deformation and has a large entryway opening for the animal, a top opening to pour granular cat litter and handle openings on the curvature of the animal waste receptacle. For example, tall 200 Series Stainless Steel trash bins have plastic interior or framing around them to avoid deformation. A common 200 Series Stainless Steel food tray is only 6-8 inches in height which is too shallow to fill a minimum 2 inch litter level most veterinarians recommend to allow animal to urinate or defecate and bury waste. A 6-8 inch wall height is ineffective to retain high urination against the wall. And 200 Series Stainless Steel with low nickel content is not corrosion resistant enough to hold corrosive cat urine. A common stainless steel food tray that is 6-8 inches tall could not be successfully used as an animal waste receptacle and cat waste receptacle.

To avoid having to use plastic and non-stick or Teflon® coating that is frequently used in animal waste receptacles, a finely milled brushed interior surface to break up the contact surface and reduce wet animal waste and granular cat litter sticking to the surface.

### SUMMARY OF THE INVENTION

Embodiments of the present invention include an animal litter container and materials and surfaces used therein. Embodiments also include a lid and a removable trivet. Embodiments also include a scoop hanger for use with an animal litter scoop and an animal litter container system. Embodiments also include a removable protective liner for an entryway of an animal litter container. Embodiments also include a removable mat for use with an animal litter container. Embodiments also include a filter insert.

### BRIEF DESCRIPTION OF THE DRAWINGS

FIG. 1 is a perspective view of an exemplary embodiment of an animal litter container and accessories in accordance with one aspect of the present application;

FIG. 2 is a side elevational view of the animal litter container and accessories of FIG. 1;

FIG. 3 is a top plan view of the animal litter container and accessories of FIG. 1; and

FIG. 4 is an exploded view of components of the animal litter container and accessories of FIG. 1.

### DETAILED DESCRIPTION OF THE INVENTION

The present disclosure relates to a number of embodiments for an improved waste receptacle, as further described below.

### Container

An animal litter container comprising:
a continuous side wall extending upward from a base, the side wall having no seams between the base and a top edge;
a curved or bottom corner base-to-wall transition configured to reduce litter accumulation;
a seamless base-to-wall transition forming a curved junction having an internal angle greater than 20° or a radius of curvature greater than 0.5 inches
an entryway portion of reduced height relative to the remainder of the side wall;
at least one fill line embossed integrally with the side wall; and
wherein the container is constructed of stainless steel of at least 300-series stainless steel or 316 stainless steel with molybdenum in a preferred embodiment (but not limited to 300 series as 200 series may also be used, for example) wherein the side wall defines a closed-loop perimeter of circular, oval, polygonal, square and rectangular geometries.

At least part of the top rim edge is disconnected along the plane of the top of the litter box (101).

### Material/Surface

At least 300-series stainless steel or 316 stainless steel with molybdenum for enhanced corrosion resistance in a preferred embodiment (although in some embodiments other stainless steel alloys, but not limited to 200-series stainless steels, may also be used, despite 300-series stainless steel and in particular 316 stainless steel being preferred for corrosion resistance).

The interior surface may be textured, brushed, fine-brushed, and linear-brushed to form fine textured grooves that act as a nonstick surface, preventing litter clumps from adhering without a non-stick surface coating.

The exterior and/or interior surface of the container may have a brushed finish, characterized by visible directional brush marks that produce a textured surface. Alternatively, the surface may have a non-textured finish, such as a polished finish producing a mirror-like reflective surface, or a satin or matte finish produced by electroplating or similar surface treatment processes. Accordingly, the exterior and/or interior surface of the container may be finished with a brushed or textured surface, or with a polished, electroplated, or otherwise non-textured surface. The exterior surface may be non-textured, non-brushed, polished, or satin-finished to push out air of the suction cup and provide adhesion for silicone or plastic or rubber or another soft flexible material suction cups or other removable accessories.

### Lid

An animal litter container lid comprising:
a removable stainless steel or plastic or wood lid (30) dimensioned to cover at least part of the container opening 15, the lid having a finger opening (32) for manual removal; and
a removable silicone or plastic or rubber or another soft flexible material frame (34) dimensioned to cover at least part of the container opening 15, the silicone or plastic or rubber or another soft flexible material frame including multiple suction cups (36) spaced along its length to secure the lid 30 relative to the container 12.

In some embodiments, the silicone or plastic or rubber or another soft flexible material frame 34 (also referred to herein as a top platform) extends around substantially an entire perimeter of the opening 15. In other embodiments, the silicone or plastic or rubber or another soft flexible material frame 34 extends only partially around the perimeter of the opening 15 (for example, as an arcuate segment), such that a portion of the perimeter remains uncovered.

Where broken or dotted lines are used in the drawings, such lines may be used to indicate optional or alternate extents of the silicone or plastic or rubber or another soft flexible material frame/top platform and/or optional void/negative space, and are not intended to be limiting unless expressly recited.

### Trivet

A removable trivet for use with an animal litter container, comprising:
a silicone or plastic or rubber or another soft flexible material body (40) dimensioned to fit beneath the litter container; and
a plurality of suction cups and/or protrusions (42) spaced along its length. Suction cup can attach to bottom of litter box or hardwood floor or both.

In some embodiments, at least a portion of the protrusions (42) are configured to be received within perforations (102) to maintain elevation and/or alignment of the litter container relative to the trivet (40).

The bottom of one side of the trivet is flat and the other side is round. The trivet can be fixed or removable.

### Scooper Hook

A scoop hanger (50) for use with an animal litter scoop and an animal litter container system, comprising:
a strap, hook, or adjustable band dimensioned to secure around a handle of a litter scoop;
a connector (109) coupled to the strap, hook, or adjustable band; and
a suction cup mount (54) configured to removably engage the connector (109),
wherein the suction cup mount (54) is configured to removably adhere to a non-textured, polished, or satin-finished exterior surface of the container 12. In some embodiments, the connector (109) includes a tapered distal portion to facilitate aiming and/or positioning of the scoop hanger (50) during attachment.

In some embodiments, the suction cup mount (54) comprises a clustered suction arrangement including a plurality of suction cups arranged to provide increased stability relative to a single suction cup. For example, a plurality of smaller suction cups (e.g., four smaller suction cups) may be disposed under or adjacent a larger suction cup such that a perimeter of the plurality of smaller suction cups extends beyond a perimeter of the larger suction cup to resist peeling and/or rotation.

In some embodiments, the suction cup mount (54) has a slight curvature configured to conform to the curvature of the side wall 121.

In some embodiments, one or more suction cups of the suction cup mount (54) include a pressure-release tab (107) configured to be lifted to release vacuum pressure and facilitate removal of the suction cup mount (54) from the container 12 or other surface.

In some embodiments, the suction cup mount (54) is configured for reversible mounting such that the suction cup mount (54) may be selectively adhered to (i) an exterior surface of the container 12 or (ii) a support surface on which the container rests. In some embodiments, the suction cup mount (54) includes a rounded surface on a first side and a substantially flat surface on a second side to facilitate the reversible mounting.

### Handle (Air Vent)+Entryway Liner

A removable protective liner for an entryway of an animal litter container, comprising:
a silicone or plastic or rubber or another soft flexible material body (60) dimensioned to fit around an entryway opening of the container;
wherein the silicone or plastic or rubber or another soft flexible material body cushions contact with the container entryway and prevents injury or irritation to an animal's paws

### Air Vent+Entryway Extensions

In some embodiments, a removable entryway extender (64) is dimensioned to attach around an entryway portion of the container 12, such that the extender 64 increases an effective wall height of the entryway to reduce urine and/or litter escaping outside of the container 12.

In some embodiments, the entryway extender 64 comprises a ramp portion configured to facilitate an animal stepping over the entryway portion.

In some embodiments, the entryway extender 64 further comprises a litter-catch feature (601) positioned adjacent the entryway portion and configured to capture litter that exits the container 12 through the entry opening 20. The litter catch curves up at the end of the ramp to catch overflow litter.

In additional embodiments, a removable silicone or plastic or rubber or another soft flexible material insert (65) may be dimensioned to fit within or over a handle opening 181 and configured to block passage of liquid through the handle opening.

### Removable Mat

A removable mat (70) for use with an animal litter container, comprising:
a construction of a flexible material; a plurality of surface grooves (72) configured to capture litter particles and reduce scattering outside the mat 70; a recessed region dimensioned to receive a base of the litter container 12, the recessed region preventing unwanted movement of the container 12 and protecting underlying surfaces.

In some embodiments, the grooves 72 are curved (e.g., arcuate) to guide and retain litter particles within the mat 70.

In some embodiments, the mat 70 includes a raised peripheral rim extending around substantially an entire perimeter of the mat 70 to further reduce litter scatter beyond the mat 70.

In some embodiments, an integrated trivet portion (701) is formed integrally with the mat 70 in the litter container region. The integrated trivet portion 701 is configured to elevate the container 12 relative to the mat 70 and define an airflow gap between the container 12 and the mat 70 to reduce corrosion risk. In some embodiments, the integrated trivet portion 701 includes a rounded upper surface and a substantially flat lower surface to facilitate formation of the airflow gap.

### Filter insert

A filter insert (80) for an animal litter container, comprising:
At least 300-series stainless steel or 316 stainless steel with molybdenum in a preferred embodiment but not limited to 300 series as other grades, e.g. 200 series may be used in some embodiments.
a perforated surface having a multiple of openings in the center with an unperforated border that runs around the perforated area, two finger openings on the opposite side for manual removal (82) dimensioned to pass liquid waste while retaining solid waste above the surface
an elevated legs extending downward from the perforated surface, the legs configured to support the perforated surface above a base of the container
wherein the perforated surface and elevated legs cooperate to separate urine from feces within the container.

### Filter Litter Container

An animal litter container system comprising:
a primary litter container having a base 122 and a continuous side wall 121; a plurality of perforations (102) formed through the base 122 of the primary litter container, the perforations in the center with an unperforated border that runs around the perforated area (102) configured to pass liquid waste and/or litter particulate while retaining solid waste above the base 122; and a secondary tray (not shown) positioned beneath the primary litter container, the tray configured to collect liquid waste and/or litter particulate passing through the perforations (102).

In some embodiments, the system is configured for use with pellet-based litter, where pellet breakdown may generate particulate that passes through the perforations (102) and is collected in the secondary tray.

The manufacturing process used to manufacture waste receptacles according to the present invention includes:
Step 1 is fully laser cut through the outlines of the vertical wall from at least 1.2 mm gauge 300 Series Austenitic stainless steel plate.
Step 2 is fully laser cut through the outline of the round bottom from at least 1.2 mm gauge 300 Series Austenitic stainless steel plate.
Step 3 is partially laser cutting through the outlines of the U-shape entryway height no less than ⅓ and no greater than ⅔ of the total vertical wall height and no wider than 1/10 of the circumference.
Step 4 is roll the vertical wall cutout into a cylinder form.
Step 5 is roll the edge of the round bottom to create a round circumferential edge between the vertical wall and round bottom.
Step 6 is longitudinal-seam weld the seam of the cylinder vertical wall To join the opposite vertical edge of the cylinder form.
Step 7 is circumference-weld seam the round bottom to the cylinder vertical wall to attach the round bottom to the cylindrical vertical wall.
Step 8 is mill the interior and exterior with a vertical mill brush to create texture on the curved surface to increase nonstick and resistance against scratches.
Step 9 is remove the U-shaped entryway and handle openings.
Step 10 is deburr edges of the top, U-shaped entryway and handle openings.

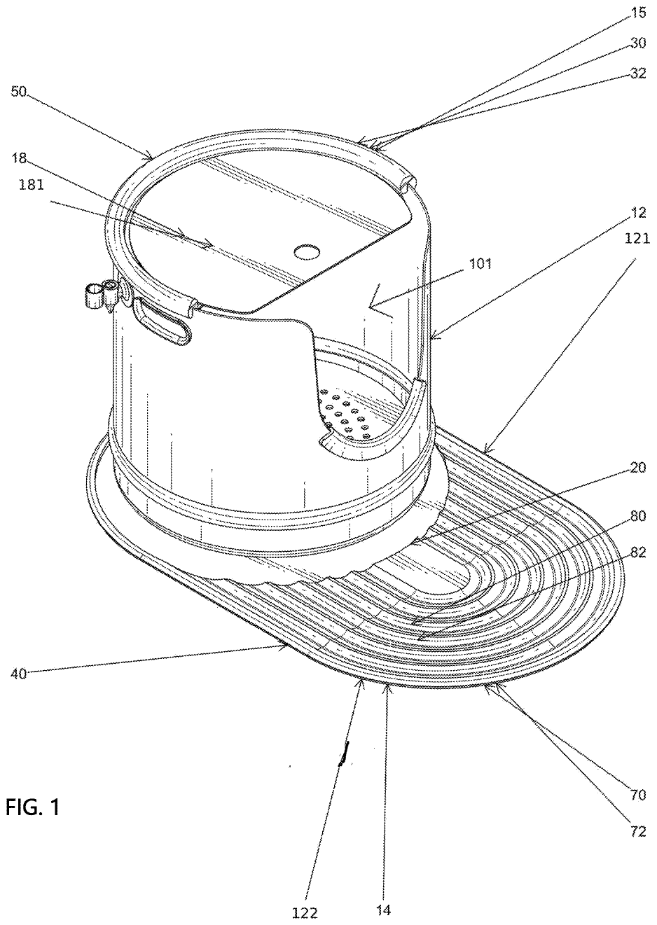

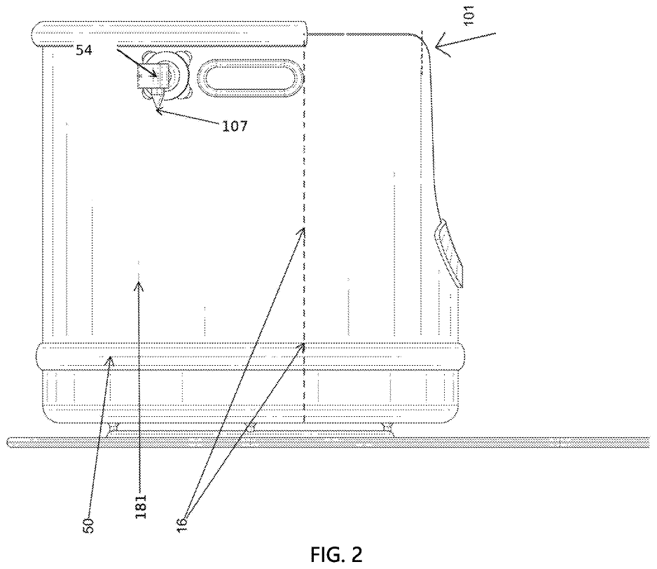

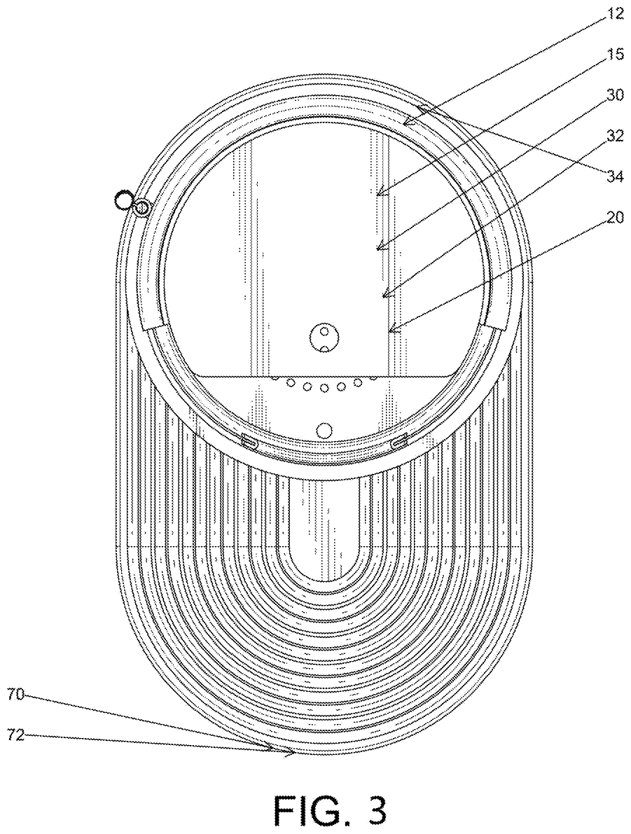

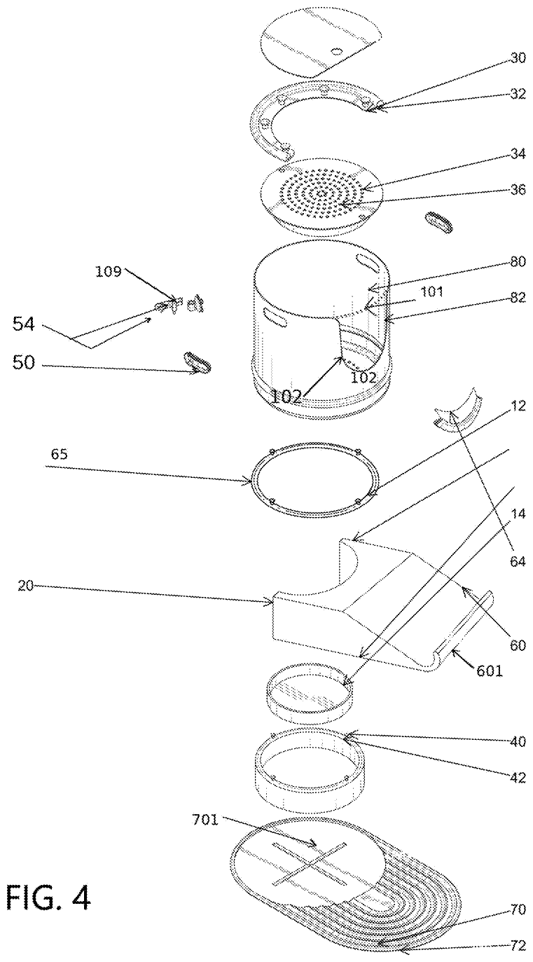

Referring to FIGS. 1-4, an animal litter container (also referred to herein as a waste receptacle or receptacle) 12 and accessories may be seen. FIG. 1 illustrates an assembled perspective view of the container 12 positioned on a mat 70, and optionally used with a lid 30 and a filter insert 80. FIG. 2 illustrates a side elevational view of the container 12 and depicts, in one embodiment, a scoop hanger 50 removably mounted to an exterior surface of the side wall 121 via a suction cup mount 54. FIG. 3 illustrates a top plan view of the container 12, including an entry opening 20 and optional lid components. FIG. 4 illustrates an exploded view of exemplary accessories including the lid 30 with finger opening 32, a silicone or plastic or rubber or another soft flexible material frame 34 with suction cups 36, a filter insert 80 having openings 82, a scoop hanger 50 with suction cup mount 54 and connector 109, an entryway liner 60, an entryway extender 64, a silicone or plastic or rubber or another soft flexible material insert 65, a trivet/raiser 40 with suction cups 42, and a mat 70 having grooves 72 and an integrated trivet portion 701.

In accordance with one embodiment, the receptacle 12 may be formed of a floor 122. A side wall 121 may extend up from around a perimeter of the floor 122 forming the receptacle 12 with the open top area 15. The side wall is perpendicular to the floor and the outline of the top of the receptacle is parallel to the outline of the floor. The side wall is at least 1.2 mm gauge 300 Series Austenitic stainless steel plate and the floor is at least 1.2 mm gauge 300 Series Austenitic stainless steel plate.

In some embodiments, at least a portion of the top rim edge of the container 12 is interrupted or disconnected (101) along the plane of the top opening 15. The rim interruption 101 may define a discontinuity in the top rim profile and may be configured to facilitate interaction with an accessory without requiring a seam between the base 122 and side wall 121.

Located in a bottom interior of the receptacle 12 may be a rounded/curved edge 14 (hereinafter rounded edge). The rounded edge 14 may be formed where the side wall 121 of the receptacle 12 meets with the floor 122 of the receptacle 12. The rounded edge 14 be easier to clean and may prevent any build up or difficulty in removing the litter and animal waste from the receptacle 12. Most prior art waste receptacles may use a receptacle having a sharper edge formed between the side wall of the receptacle and the floor. The sharper edge area is more difficult to clean and may be an area where the litter and animal waste collect.

A fill line 16 may be formed on the receptacle 12. In accordance with one embodiment, the fill line 16 may be formed on the side wall 121. The fill line 16 may indicate an amount of granular cat litter that should be placed in the interior of the receptacle 12. The fill line 16 may be formed two to three inches above the floor 122 of the receptacle 12. In accordance with one embodiment, the fill line 16 may be embossed along a perimeter of the receptacle 12. The fill line 16 may be formed either along an exterior perimeter of the receptacle 12 or an interior perimeter of the receptacle 12. In accordance with one embodiment, the fill line 16 may be formed along an interior perimeter of the receptacle 12 to allow one to more easily see the fill line 16 when adding the granular cat litter to the receptacle 12. Embossing the fill line 16 may protect the fill line 16 from damage such as scratching from an animal and normal wear and tear thereby allowing the fill line 16 to last a longer period of time. The fill line is embossed in the thin sheet stainless steel material of the container to create a raised area along an exterior perimeter of the container and the embossing on the exterior creates a visible depression along an interior perimeter of the container in a corresponding position and wherein the fill line curves raised on the exterior in a semi-ellipse shape relative to the plane of the container and a corresponding semi-ellipse channel is formed on the corresponding interior aspect. The top of the fill line above the channel is coplanar with the bottom of the fill line below the channel, so the fill line forms a continuous radius of curvature with the vertical height of two parallel coplanar lines maintained. The litter box can be rotated in any direction and positioned in any part of a preferred location the fill line will be viewable in the same way, so that the fill line can be partially obscured by external objects like a sofa or a chair or a closet and still be visible. The channel within the fill line is deep enough to contain the grains of even the largest litter manufacturers, for example, Pretty Litter and tofu-based litter and pellets of chipped wood-based litter. The fill line is wide enough to accommodate a human finger or a litter scoop, allowing the fill line to be easily cleaned and preventing accumulation of litter or waste. The fill line is 2-3 inches above the floor and at least 5 inches down from the top rim of the container.

A pair of handles 18 may be fowled on opposing sides of the receptacle 12. The handles 18 may be used to pick-up and move the receptacle 12. In accordance with one embodiment, the handles 18 may be a pair of elongated oval openings 181 formed on opposing sides of the receptacle 12 such as a left side and a right side of the receptacle 12.

An opening 20 may be formed in a front area of the receptacle 12. The opening 20 may allow an animal to enter the interior of the receptacle 12. In accordance with one embodiment, the opening 20 may be a “U” shape opening. The bottom of the “U” shape opening 20 should be of sufficient height to keep the granular cat litter within the interior of the receptacle 12 but not be too high to prevent the animal from entering. In accordance with one embodiment, the bottom of the “U” shape opening 20 may be a minimum of four inches above the floor 122 of the receptacle 12. The outline of the U-shape entryway height is no greater than ⅔ of the total vertical wall height and no wider than 1/10 of the total circumference. The “U” shaped opening is set back recessed inwards towards the center of the litter box offset at an angle so that the opening is behind the plane of the container viewed from the side.

The letters pH stand for potential of hydrogen. A pH level is effectively a measure of the concentration of hydrogen ions (that is, protons) in a substance. Normal cat urine pH should be in the range of 6 to 6.5. However, various conditions and/or diet can either raise or lower urine pH in cats. A lower pH generally means that the cat urine is more acidic. A higher pH generally means that the cat urine is more alkaline. A major consideration is that abnormal urinary pH can promote the formation of crystals/stones that can irritate and/or obstruct the urinary tract of the cat. Further, more acidic urine may have a tendency to speed up the deterioration of prior art waste receptacles.

Many people may be under the assumption that all stainless steel is resistant to corrosion can easily be mold or casted from a machine, however, this is generally not true. Metal production generally require custom toolings and high manual skills. The lower the grade of the stainless steel, the higher the rate of corrosion that may occur. For example, many inexpensive stainless steel products you may find on Amazon® and Ikea® may be made of 201 or 200 series stainless steel. It may be hard to tell from the outside since all stainless steel may look the same. However, 200 series stainless steel eventually rust within 1-2 years even if they are not contacted with liquid but just sitting in a humid environment.

It has been shown, that certain solutions, may cause corrosion cracking in stainless steel. When passive metals such as the stainless steels corrode, the corrosion develops where passivity has been destroyed. This may occur at very small areas and result in a pitted surface. Once the passivity has been lost at a local spot, this area will be anodic to the remaining passive surface.

Increasing carbon content tends to increase susceptibility to sensitization. Holding the carbon content to a maximum of 0.03 percent, as found in higher 300 series of stainless steel, may be sufficient to avoid sensitization. Additions of titanium or columbium may also serve to inhibit the development of sensitization. Therefore, if the low carbon grades are not used, 300 series may be recommended for use in corrosive environments.

Thus, the present receptacle 12 may be formed of a seamless, crevice-free, rivet-free and austenitic 300 series of stainless steel. A receptacle formed of 300 series stainless steel will not absorb odors, grow bacteria, mold, leave stains, rust or build up residues like the plastic, rubber, and low-grade stainless steel waste receptacles currently available. In accordance with one embodiment, the receptacle 12 may be formed of 316 “marine” grade stainless steel.

Having a seamless, crevice-free, rivet-free receptacle 12 may be important as grain boundaries have less resistance to corrosion. Welding and drilling operations, for example, may leave an area near the welds and cuts in such a corrosion-susceptible or “sensitized” condition. The intergranular corrosion of a sensitized steel can be insidious, in that after such attack the steel sometimes appears relatively sound, but on more detailed examination may be found to possess very little strength.

The animal waste receptacle of the present invention can be provided with a lid with a stainless steel center and malleable silicone or plastic or rubber or another soft flexible material rim which can conform to the shape of the present invention. A plastic or stainless steel lid would not easily conform to the shape, but a malleable silicone or plastic or rubber or another soft flexible material rim surrounding a stainless steel center will.

In some embodiments, the lid may have a folding hinge provides a means to access the animal waste receptacle, which may be positioned in the middle of the lid or at an end of the lid. Groove clips around the top edge of the animal waste receptacle to secure the lid to the animal waste receptacle. 300 series stainless steel lid connects to silicone or plastic or rubber or another soft flexible material platform to support the 300 series stainless steel lid. Soft and malleable rim is typically made of silicone or plastic or rubber or another soft flexible material.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description.

Other embodiments may be utilized and derived from the present invention, such that structural and logical substitutions and changes may be made without departing from the scope of this disclosure.

Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments.

Where broken or dotted lines are used in the drawings, such lines may depict optional, alternate, or non-limiting features (including optional extents of components and/or void/negative space) and are not intended to limit the disclosure unless expressly recited.

Combinations of the above embodiments, and other embodiments not specifically described herein, will be apparent to those of skill in the art upon reviewing the above description. Therefore, it is intended that the disclosure not be limited to the particular embodiment(s) disclosed.

### REFERENCE NUMERALS

12 Receptacle/container
121 Side wall
122 Floor/base
14 Rounded/curved base-to-wall transition
15 Open top area
16 Fill line
18 Handles
181 Handle openings (air vent/handles)
20 Entry opening
30 Lid (stainless lid panel)
32 Finger opening in lid
34 Silicone or plastic or rubber or another soft flexible material frame (rim/top platform) for lid
36 Suction cups (lid frame)
40 Trivet/raiser (beneath container)
42 Suction cups and/or protrusions (trivet/raiser)
50 Scoop hanger
54 Suction cup mount (scoop hanger)
60 Entryway liner (protective liner)
64 Entryway extender
65 Silicone or plastic or rubber or another soft flexible material insert (handle opening insert)
70 Mat
72 Mat grooves
80 Filter insert
82 Openings/perforations (filter insert)
101 Top rim discontinuity/disconnected rim edge
102 Perforations through base (sifter embodiment)
107 Pressure-release tab(s) (suction mount)
109 Connector (scoop hanger)
601 Litter-catch feature (entryway extender)
701 Integrated trivet portion of mat

What is claimed is:

1. An animal litter container comprising: a continuous side wall extending upward from a base, the side wall having no seams between the base and a top edge; a curved or bottom corner base-to-wall transition configured to reduce litter accumulation; a seamless base-to-wall transition forming a curved junction having an internal angle greater than 20 degrees or a radius of curvature greater than 0.5 inches; an entryway portion of reduced height relative to the remainder of the side wall; at least one fill line embossed integrally with the side wall; wherein the container is constructed of stainless steel of at least 300-series stainless steel or 316 stainless steel with molybdenum or 200 series; wherein the side wall defines a closed-loop perimeter of circular, oval, polygonal, square, or rectangular geometry; and wherein at least part of a top rim edge is disconnected (101).

2. The animal litter container of claim 1, wherein the litter container is made of 316 stainless steel with molybdenum for enhanced corrosion resistance.

3. The animal litter container of claim 1, wherein the interior surface is textured, brushed, fine-brushed, or linear-brushed to form fine grooves that act as a nonstick surface to reduce litter clump adhesion without a non-stick coating.

4. The animal litter container of claim 1, wherein the exterior surface is non-textured, non-brushed, polished, or satin-finished to provide adhesion for silicone or plastic or rubber or another soft flexible material suction cups or other removable accessories.

5. The animal litter container of claim 1, further comprising an animal litter container lid comprising: a removable wood or plastic or stainless steel lid dimensioned to cover at least part of the container opening, the lid having a finger opening for manual removal; and a removable silicone or plastic or rubber or another soft flexible material frame dimensioned to cover at least part of the container opening, the silicone or plastic or rubber or another soft flexible material frame including a plurality of suction cups spaced along its length to secure the lid relative to the container.

6. The animal litter container of claim 5, wherein the stainless steel lid is formed of at least 200 series or 300-series stainless steel or 316 stainless steel with molybdenum.

7. The animal litter container of claim 5, wherein an underside surface of the lid is flat, non-textured, non-brushed, polished, or satin-finished to provide adhesion for suction cups or other removable accessories.

8. The animal litter container of claim 5, wherein a top surface of the lid is textured, brushed, fine-brushed, or linear-brushed to form fine grooves that act as a nonstick surface to reduce litter clump adhesion without a non-stick coating.

9. The animal litter container of claim 1, further comprising a removable trivet for use with the animal litter container, comprising: a silicone or plastic or rubber or another soft flexible material body dimensioned to fit beneath the litter container; and a plurality of suction cups spaced along its length.

10. The animal litter container of claim 1, further comprising a scoop hanger for use with an animal litter scoop, comprising: a strap or adjustable band dimensioned to secure around a handle of a litter scoop; a connector (109); and a suction cup mount configured to removably engage the connector (109), wherein the suction cup mount is configured to removably adhere to the exterior surface of the animal litter container.

11. The animal litter container of claim 1, further comprising a removable protective liner for an entryway of the animal litter container, comprising: a silicone or plastic or rubber or another soft flexible material body dimensioned to fit around an entryway opening of the container, wherein the silicone or plastic or rubber or another soft flexible material body cushions contact with the container entryway and reduces irritation to an animal's paws.

12. The animal litter container of claim 1, further comprising a removable liner system for the animal litter container, comprising: a silicone or plastic or rubber or another soft flexible material insert dimensioned to fit within or over a handle opening of the container, the silicone or plastic or rubber or another soft flexible material insert configured to block passage of liquid or urine through the handle opening; and a removable entryway extender dimensioned to attach around an entryway portion of the container, the entryway extender increasing the effective wall height of the entryway to reduce urine from escaping outside of the container; wherein the entryway extender (64) includes a ramp portion configured to facilitate an animal stepping over the entryway portion, wherein the entryway extender (64) comprises a litter-catch feature (601) positioned adjacent the entryway portion and configured to capture litter exiting the container through the entryway portion.

13. The animal litter container of claim 1, further comprising a removable mat for use with the animal litter container, comprising: a flexible construction; a plurality of surface grooves configured to capture litter particles and reduce scattering outside the mat; a recessed region dimensioned to receive a base of the litter container; and an integrated trivet region configured to elevate the litter container and provide airflow between the litter container and the mat to reduce corrosion; wherein the mat (70) comprises a raised peripheral rim extending around at least a majority of a perimeter of the mat (70) to reduce litter scatter beyond the mat (70).

14. The animal litter container of claim 1, further comprising a filter insert for the animal litter container, comprising: a perforated surface having a plurality of openings dimensioned to pass liquid waste while retaining solid waste above the surface; and elevated legs extending downward from the perforated surface, the elevated legs configured to support the perforated surface above a base of the container; wherein the perforated surface and elevated legs cooperate to separate urine from feces within the container.

15. The animal litter container of claim 1, wherein an inner surface is textured, brushed, fine-brushed, or linear-brushed to form fine grooves that act as a nonstick surface to reduce litter clump adhesion without a non-stick coating.

16. The animal litter container of claim 1, wherein an outer surface is non-textured, non-brushed, polished, or satin-finished to provide adhesion for suction cups or other removable accessories.

17. The animal litter container of claim 1, wherein the animal litter container comprises a sifter litter container system including: a primary litter container having a base and a continuous side wall; a plurality of perforations formed through the base of the primary litter container, the perforations configured to pass liquid waste while retaining solid waste above the base; a secondary tray positioned beneath the primary litter container, the secondary tray configured to collect liquid waste passing through the perforations; and a litter container raiser dimensioned to fit beneath the primary litter container to elevate the primary litter container from a floor surface; wherein the plurality of perforations through the base comprises perforations (102), and wherein the secondary tray is configured to collect at least liquid waste and litter particulate passing through the perforations (102).

18. The animal litter container of claim 10, wherein the suction cup mount (54) comprises a clustered suction arrangement including a first suction cup and a plurality of secondary suction cups disposed under and/or adjacent the first suction cup to increase mounting stability.

19. The animal litter container of claim 18, wherein the suction cup mount (54) has a curvature configured to conform to a curvature of the side wall (121).

20. The animal litter container of claim 18, wherein the suction cup mount (54) includes one or more pressure-release tabs (107) configured to facilitate removal of the suction cup mount (54) from a surface; and wherein the suction cup mount (54) is configured to selectively mount to (i) an exterior surface of the container and (ii) a support surface on which the container rests.
